(19) United States
(12) Patent Application Publication
(10) Pub. No.: US 2024/0196430 A1
(43) Pub. Date: Jun. 13, 2024

(54) COMMUNICATION DEVICES AND METHODS

(71) Applicant: Sony Group Corporation, Tokyo (JP)

(72) Inventors: Thomas HANDTE, Sttutgart (DE); Dana CIOCHINA-KAR, Sttutgart (DE); Daniel VERENZUELA, Sttutgart (DE)

(73) Assignee: Sony Group Corporation, Tokyo (JP)

(21) Appl. No.: 18/286,557

(22) PCT Filed: Apr. 20, 2022
(86) PCT No.: PCT/EP2022/060337

§ 371 Date: Oct. 12, 2023

(30) Foreign Application Priority Data
Apr. 20, 2021 (EP) 21169494.8

(51) Int. Cl. H04W 74/04; H04W 74/00; H04W 76/30

(52) U.S. Cl. CPC H04W 74/04; H04W 74/002; H04W 76/30

(57) ABSTRACT

A first communication device is configured to communicate with a third communication device, the first communication device comprising circuitry configured to perform data exchange with the third communication device during a first portion of a scheduling interval, wherein data exchange between the first and the third communication device is planned during the scheduling interval, the first communication device being a primary user of the scheduling interval: and transmit a release indication indicating that the remaining portion of the scheduling interval is released for use by a second communication device, the second communication device being a secondary user of the scheduling interval.

### BACKGROUND

### Field of the Disclosure

The present disclosure relates to different communication devices and methods that are configured to communicate with each other, in particular as used in a wireless communication system. The present disclosure particularly relates to an access point (AP; herein also called AP STA (station) or third communication device) and to stations (STAs, herein also called non-AP STAs) including a station being a primary user of a scheduling interval (herein also called first communication device) and a station being a secondary user of the scheduling interval (herein also called second communication device).

### Description of Related Art

WLAN features a technology called target wake time (TWT) that was originally designed for power saving purposes, but it has become relevant to control the number of communication devices that access the channel at the same time. TWT defines, via an agreement between AP STA (also called TWT responding STA) and one or more non-AP STAs (also called TWT requesting STAs) within the TWT setup, intervals in which non-AP STAs should be awake to receive data from the AP STA and/or should transmit to the AP STA. These intervals are referred to as TWT service periods (TWT SPs; herein also called scheduling intervals). The AP STA may therefore control the number of non-AP STAs that access the channel within a particular interval, i.e. the number of non-AP STAs with which data communication of the AP STA is planned during this scheduling interval. During such an interval any STA may or may not access the channel, i.e. it is a time interval that is “reserved” for non-AP STAs to communicate. Thus, the number of STAs that contend for channel access is limited.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly or impliedly admitted as prior art against the present disclosure.

### SUMMARY

It is an object to provide communication devices and methods that enable an efficient use of a scheduling interval. It is a further object to provide a corresponding computer program and a non-transitory computer-readable recording medium for implementing said communication methods.

According to an aspect there is provided a first communication device configured to communicate with a third communication device, the first communication device comprising circuitry configured to
perform data exchange with the third communication device during a first portion of a scheduling interval, wherein data exchange between the first and the third communication device is planned during the scheduling interval, the first communication device being a primary user of the scheduling interval; and
transmit a release indication indicating that the remaining portion of the scheduling interval is released for use by a second communication device, the second communication device being a secondary user of the scheduling interval.

According to a further aspect there is provided a second communication device configured to communicate with a third communication device, the second communication device comprising circuitry configured to
stay awake during a scheduling interval, wherein data exchange between the third communication device and a first communication device is planned during the scheduling interval, the first communication device being a primary user of the scheduling interval and the second communication device being a secondary user of the scheduling interval;
listen to a release indication indicating that the remaining portion of the scheduling interval is released for use by the second communication device; and
contend for channel access and/or perform data exchange with the third communication device during at least the remaining portion of the scheduling interval if
i) a release indication is received or
ii) no data exchange between the first communication device and the third communication device is observed for at least an inactivity interval.

According to a further aspect there is provided a third communication device configured to communicate with a first and/or second communication device, the third communication device comprising circuitry configured to
perform data exchange with the first communication device during a first portion of a scheduling interval, wherein data exchange between the third communication device and the first communication device is planned during the scheduling interval, the first communication device being a primary user of the scheduling interval; and
i) receive a first release indication from the first communication device indicating that the first communication device has finished data exchange with the third communication device during the scheduling interval and transmit a second release indication indicating that the remaining portion of the scheduling interval is released for use by a second communication device, the second communication device being a secondary user of the scheduling interval, or
ii) transmit a first release indication indicating that the third communication device has finished data exchange with the first communication device during the scheduling interval, receive a second release indication from the first communication device indicating that the remaining portion of the scheduling interval is released for use by a second communication device, and repeat the transmission of the second release indication, or iii) transmit a second release indication or other information indicating or allowing a
second communication device to determine that the remaining portion of the scheduling interval is released for use by a second communication device.

According to still further aspects a computer program comprising program means for causing a computer to carry out the steps of the methods disclosed herein, when said computer program is carried out on a computer, as well as a non-transitory computer-readable recording medium that stores therein a computer program product, which, when executed by a processor, causes the methods disclosed herein to be performed are provided.

Embodiments are defined in the dependent claims. It shall be understood that the disclosed communication methods, the disclosed computer program and the disclosed computer-readable recording medium have similar and/or identical further embodiments as the claimed communication devices and as defined in the dependent claims and/or disclosed herein.

A TWT SP (i.e. a scheduling interval) can be protected to achieve a successful data transfer with high likelihood making it suitable for low-latency data transfer. However, the design of a TWT SP is difficult, because the time it takes for a STA to successfully transfer its data is unpredictable. Thus, TWT SP durations may be designed with a margin and some portion may often be non-used, consequently the spectral efficiency drops. It is hence proposed according to the present disclosure to differentiate primary and secondary users within a TWT SP. A primary user may access the channel first, whereas a secondary user may access the channel after the TWT SP has been released by the primary user. The secondary user may thus fill the remaining time of the TWT SP that would be unused otherwise. Mechanisms for releasing the TWT SP are disclosed herein as well.

It is noted that in the context of the present disclosure the expressions “data exchange” and “data communication” shall be understood in a broad sense and as synonyms. Data exchange and data communication include uni- and bi-directional communication, i.e. transmission and/or reception of data. “Data” shall hereby be understood in a broad sense to include any kind of data, such as content data, user data, control information, management information or any combination of such data. The term “frames” is often used as a synonym for “data”, i.e. the exchange/communication of (any kinds of) frames shall also be understood as falling under the expressions “data exchange” and “data communication”.

It is noted that in the context of the present disclosure the releasing the remaining portion does not mean that only the secondary user can then access the channel and use the remaining portion for data exchange with the third communication device, but the primary user and/or one or more secondary users may contend for channel access and data exchange during the remaining portion.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows a diagram illustrating a known TWT setup and TWT SP with two transmission opportunities (TXOPs).

FIG. 2 shows diagrams illustrating a TWT SP and a restricted TWT SP (R-TWT SP).

FIG. 3 shows a diagram illustrating length setting of R-TWT SP with margin that may be used for retransmission occasionally required.

FIG. 4 shows a diagram illustrating a communication system including a first communication device, a second communication device and a third communication device according to the present disclosure.

FIG. 5 shows a flow chart of an embodiment of a first communication method of the first communication device according to the present disclosure.

FIG. 6 shows a flow chart of an embodiment of a second communication method of the second communication device according to the present disclosure.

FIG. 7 shows a flow chart of an embodiment of a third communication method of the second communication device according to the present disclosure.

FIG. 8 shows a diagram illustrating a first embodiment of a communication scheme according to the present disclosure.

FIG. 9 shows a diagram illustrating a second embodiment of a communication scheme according to the present disclosure.

FIG. 10 shows diagrams illustrating a third embodiment of a communication scheme according to the present disclosure.

FIG. 11 shows a diagram illustrating a fourth embodiment of a communication scheme according to the present disclosure.

FIG. 12 shows a diagram illustrating a fifth embodiment of a communication scheme according to the present disclosure.

FIG. 13 shows a diagram illustrating a sixth embodiment of a communication scheme according to the present disclosure.

FIG. 14 shows a diagram illustrating a seventh embodiment of a communication scheme according to the present disclosure.

FIG. 15 shows a diagram illustrating an eighth embodiment of a communication scheme according to the present disclosure.

FIG. 16 shows a diagram illustrating an ninth embodiment of a communication scheme according to the present disclosure.

FIG. 17 shows a diagram illustrating a known trigger-enabled TWT.

FIG. 18 shows a diagram illustrating a known trigger-enabled TWT with buffer status (BS) poll.

FIG. 19 shows a diagram illustrating a tenth embodiment of a communication scheme according to the present disclosure.

FIG. 20 shows a diagram illustrating an eleventh embodiment of a communication scheme according to the present disclosure.

FIG. 21 shows a diagram illustrating a twelfth embodiment of a communication scheme according to the present disclosure.

FIG. 22 shows a diagram illustrating a thirteenth embodiment of a communication scheme according to the present disclosure.

FIG. 23 shows a diagram illustrating a fourteenth embodiment of a communication scheme according to the present disclosure.

FIG. 24 shows a diagram illustrating a fifteenth embodiment of a communication scheme according to the present disclosure.

### DETAILED DESCRIPTION OF THE EMBODIMENTS

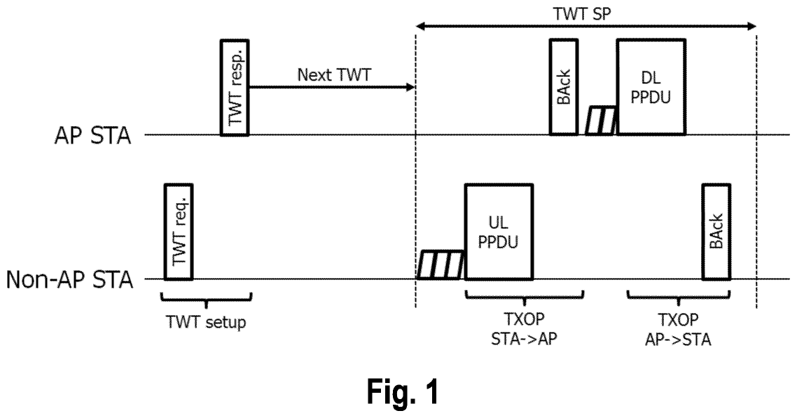

Referring now to the drawings, wherein like reference numerals designate identical or corresponding parts throughout the several views, FIG. 1 shows a diagram illustrating the TWT setup phase holding TWT request and TWT response followed by a TWT SP (scheduling interval) in which two frame exchanges or transmission opportunities (TXOPs) are initiated by the non-AP STA and AP STA, respectively. In this implementation, the TWT response holds a pointer to the next TWT SP. In other implementations, the TWT response may hold a pointer to a beacon frame that holds a schedule identifying each STA's TWT SP starting time. There are also options to have a persistent interval in between subsequent TWT SP of same STAs.

The TWT agreement is type of a loose agreement between AP STA and non-AP STAs. Therefore, if a non-AP STA has urgent data to transmit to the AP STA, it may violate the TWT agreement and transmit the data at any time. Generally, all STAs regardless if they belong to a current TWT SP or not, apply regular distributed channel access mechanism, i.e. they apply the well-known backoff procedures as defined in e.g. the WLAN EDCA (enhanced distributed channel access) mechanism or well-known trigger based channel access of WLAN via e.g. trigger frame followed by trigger based (TB) data units (in this example physical layer protocol data units (PPDUs)). In general, a STA that requested for TWT should not transmit frames outside of the negotiated TWT SPs and should not transmit frames that are not contained within TB PPDUs to the TWT responding STA within trigger enabled TWT SPs. A TWT requesting STA decides which frames to transmit at which point in times; hence, it may violate the TWT SP although it is not recommended.

In IEEE 802.11be it was agreed that TWT should be the baseline to control channel access to achieve a more predictable data delivery time. Restricted R-TWT (herein understood as scheduling interval as well) has been introduced which is the same as a regular TWT, but all STAs within the same basic service set (BSS) should end any TXOP before the beginning of the defined R-TWT SP.

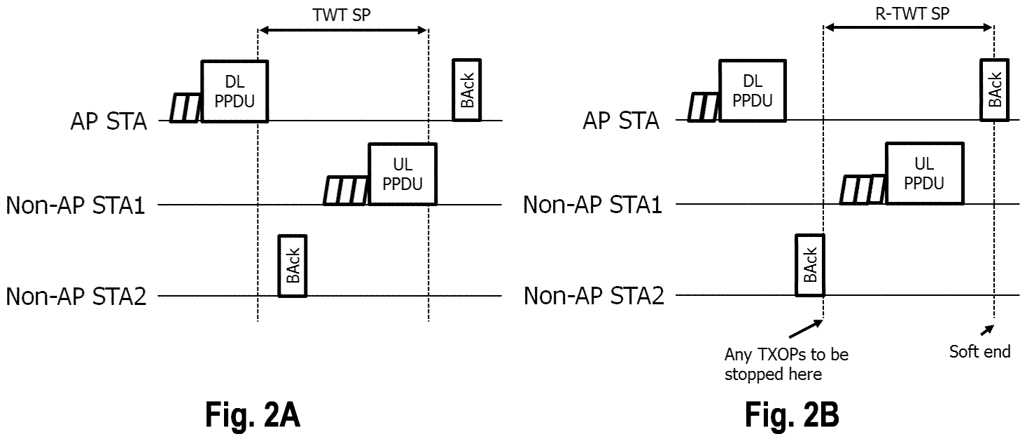

FIG. 2 shows diagrams that illustrate the difference between a TWT SP (FIG. 2A) and a R-TWT SP (FIG. 2B). By stopping all TXOP before the beginning of R-TWT, STA1 gets its data delivered more predictable than in case of a regular TWT-SP, where the borders are soft. The end of a R-TWT SP may be exceeded by a TXOP unless the R-TWT SP is followed by another R-TWT SP with which the TXOP would overlap. Thus, in R-TWT just the beginning is “protected” by the requirement to stop all TXOPs.

A (R-)TWT SP defines a temporal period. However, it is difficult to define a temporal length of a data transmission because the transmission time of a data packet with known length depends on transmit parameters such as modulation coding scheme (MCS), bandwidth (BW), and/or spatial streams. These parameters may instantly change due to environment change or mobility of the STAs. Additionally, ARQ (automatic repeat request) makes the time until successful data delivery unpredictable as one or more retransmissions may be needed to successfully transmit a data unit to the receiving STA. On top of these issues the transmit time may be also unpredictable because the data unit size is unknown or has a certain variance around a mean value.

Since TWT agreements should be long term stable to avoid overhead (such as delay, throughput loss) by reconfiguration, the time allocated for a TWT SP is selected with some margin to the average expected delivery time for successful data transmission. Thus, successful data delivery within a TWT SP, in which one or more STAs have preferred channel access, can be guaranteed with high likelihood. The larger the margin, the higher the likelihood.

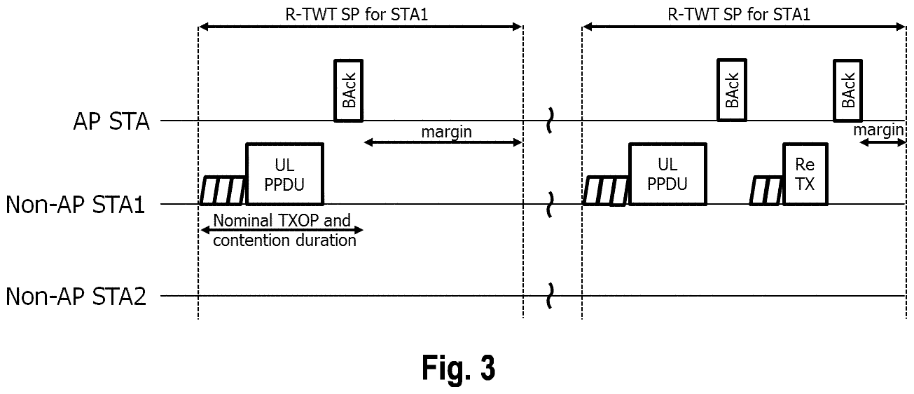

Generally, if a TWT SP is selected too small, the likelihood of successful data transfer is small, whereas if it is selected too large, most time of the TWT SP tends to be unused. Thus, for low latency traffic, the latter option may often be chosen, which results in lower aggregated throughput within the BSS, because the TWT SP is underused. This issue is outlined in FIG. 3 showing a diagram illustrating length setting of R-TWT SP with margin that may be used for occasionally required retransmission. Naturally, STAs could violate the TWT SP and use this transmit time, however it may be unclear for STAs if the TWT SP is non-used, because the TWT SP entitled STAs are hidden or perform long backoff count down, e.g. after a PPDU collision (i.e. a failed PPDU). Therefore, this is not a good solution for applications where more predictability of data transfer is desired.

FIG. 3 illustrates the nominal TXOP and contention period as well as the margin that may absorb a potential retransmission. As retransmissions may happen rarely, the margin is often unused resulting in low efficiency of the protocol.

According to the present disclosure the concept of a primary user and a secondary user of a scheduling interval is introduced. The non-AP STAs are assigned by the AP STA to belong to primary and secondary users of a TWT SP, e.g. during the setup phase. The AP STA may consider non-AP STAs' preferences indicated in a TWT request. A primary user (herein also called first communication device) is entitled to access the channel within a TWT SP right after it begins, i.e. to use a first portion of the scheduling interval (up to the complete scheduling interval). A secondary user (herein also called second communication device) should be awake during the TWT SP, but only access the channel once it has obtained a TWT SP release indication by the primary user or the AP STA.

A secondary user STA may consider not to be awake during the TWT SP if two conditions are fulfilled: (i) it has no data to transmit and (ii) the AP has no data to transmit to the STA. For condition (ii) a signaling between AP and STA may be used. This will be explained in more detail below.

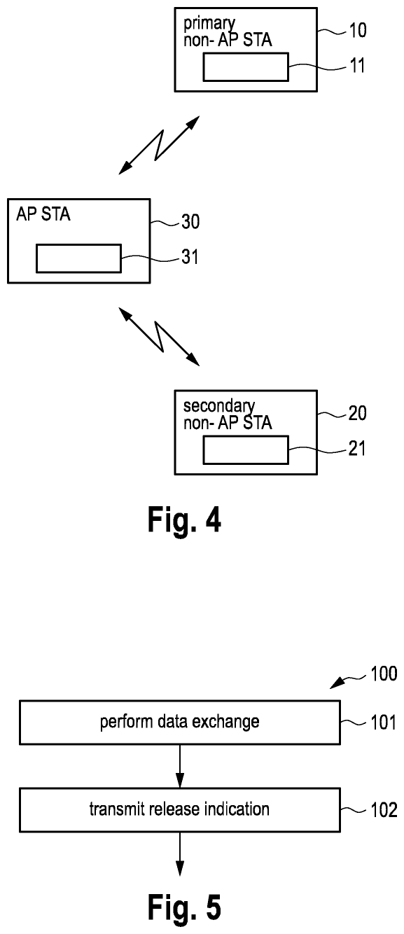

FIG. 4 shows a diagram illustrating a communication system including a first communication device 10, a second communication device 20 and a third communication device 30 according to an aspect of the present disclosure. The third communication device 30 (the AP or AP STA) is configured to communicate with one (or more) first communication device(s) 10 (non-AP STA(s)) representing primary users of the scheduling interval during which communication of the AP STA 30 with the one (or more) primary user(s) 10 (i.e., communication devices that have a membership of the scheduling interval) is planned. Further shown is a second communication device 20 (other non-AP STA) with which communication of the AP STA 30 is planned during the scheduling interval as a secondary user, i.e., which does not have primary user membership of the scheduling interval. In general, first and second communication devices can be seen as having different priority. While first communication devices may readily access the channel right after a TWT SP begins, second communication devices need to await a TWT SP release indication; hence, they cannot access the TWT SP from the beginning. While only two stations are shown in FIG. 4, in a practical embodiment of the system there may be more stations. The third communication device 30 is generally able to exchange (receive and/or transmit) data/frames with the first communication device(s) 10 and the second communication device(s) 20.

Each of the communication devices 10, 20, 30 comprises circuitry 11, 21, 31 that is configured to perform particular operations. The circuitries may be implemented by a respective processor or computer, i.e., as hardware and/or software, or by dedicated units or components. For instance, appropriately programmed processors may represent the respective circuitries 11, 21, 31

FIG. 5 shows a flow chart of an embodiment of a first communication method 100 of the first communication device 10 according to the present disclosure, which may be performed by the circuitry 11. In a first step 101 the first communication device performs data exchange (i.e. data communication, uni- or bidirectional) with the third communication device during a first portion of a scheduling interval, wherein data exchange between the first and the third communication device is planned during the scheduling interval, the first communication device being a primary user of the scheduling interval. In a second step 102 the first communication device transmits a release indication indicating that the remaining portion of the scheduling interval is released for use by a second communication device, the second communication device being a secondary user of the scheduling interval.

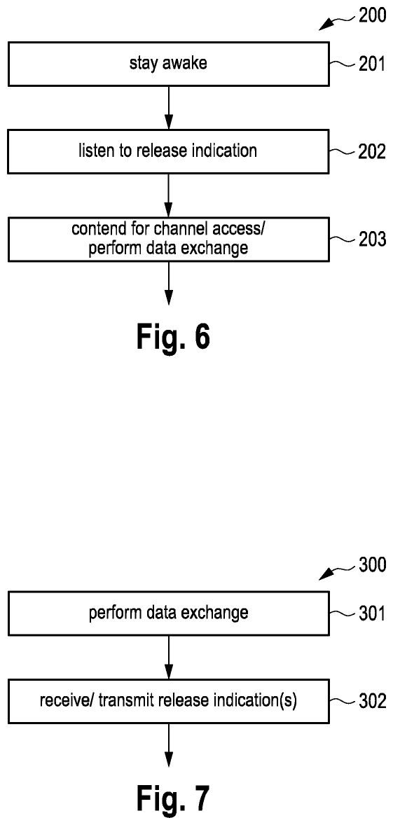

FIG. 6 shows a flow chart of an embodiment of a second communication method 200 of the second communication device 20 according to the present disclosure, which may be performed by the circuitry 21. In a first step 201 the second communication device stays awake during a scheduling interval, wherein data exchange between the third communication device and a first communication device is planned during the scheduling interval, the first communication device being a primary user of the scheduling interval and the second communication device being a secondary user of the scheduling interval. In a second step 202 the second communication device listens to a release indication indicating that the remaining portion of the scheduling interval is released for use by the second communication device. In a third step 203 the second communication device contends for channel access and/or performs data exchange with the third communication device during at least the remaining portion of the scheduling interval if i) a release indication is received or ii) no data exchange between the first communication device and the third communication device is observed for at least an inactivity interval.

FIG. 7 shows a flow chart of an embodiment of a third communication method 300 of the second communication device 30 according to the present disclosure, which may be performed by the circuitry 31. In a first step 301 the third communication device performs data exchange with the first communication device during a first portion of a scheduling interval, wherein data exchange between the third communication device and the first communication device is planned during the scheduling interval, the first communication device being a primary user of the scheduling interval. In a second step 302 the third communication device receives and/or transmits a release indication, for which different options exist. In a first option i) it receives a first release indication from the first communication device indicating that the first communication device has finished data exchange with the third communication device during the scheduling interval and transmits a second release indication indicating that the remaining portion of the scheduling interval is released for use by a second communication device, the second communication device being a secondary user of the scheduling interval. In a second option ii) it transmits a first release indication indicating that the third communication device has finished data exchange with the first communication device during the scheduling interval, receives a second release indication from the first communication device indicating that the remaining portion of the scheduling interval is released for use by a second communication device, and repeats the transmission of the second release indication. In a third option iii) it transmits a second release indication or other information indicating or allowing a second communication device to determine that the remaining portion of the scheduling interval is released for use by a second communication device.

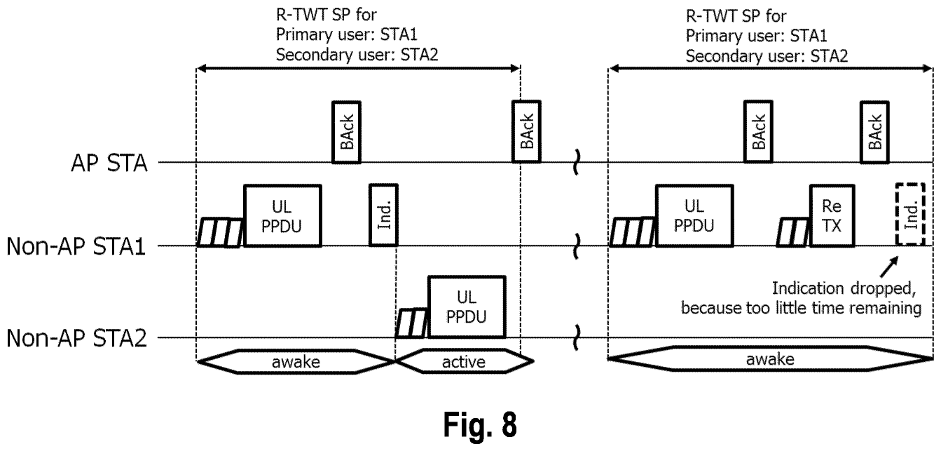

FIG. 8 shows a diagram illustrating a first embodiment of a communication scheme according to the present disclosure. According to this embodiment the primary user issues the release indication (“Ind.” in FIG. 8) to release the TWT to secondary user STAs once it successfully terminated its frame exchanges, i.e. after all data units are successfully conveyed and/or no further data units are available at the primary user for transmission.

A primary non-AP STA may refrain from transmitting the TWT SP release indication in case there is only little time left until the TWT SP ends. The remaining time after Block Ack (BAck) has been received, should be at least SIFS+TXTIME(IND) so that the indication frame fits into the remaining time of TWT SP. However, this minimum remaining time has no practical relevance for the secondary user non-AP STA.

The outlined behavior is illustrated in FIG. 8, in which during the R-TWT SP on the left hand side the primary user STA1 transmits a release indication to a secondary user STA2 that it may begin with its frame exchange or TXOP, i.e. contend for channel access. The design of the indication frame will be elaborated in more detail below. The release indication may be in the form of an indication frame, which may be transmitted in groupcast or broadcast mode and which is only considered by secondary user STAs. Since secondary users STAs are awake, they can often (exceptions see below) receive this frame and act accordingly. FIG. 8 shows on the right hand side the case in which the R-TWT SP is almost fully used by the primary user STA1 so that STA1 does not transmit a release indication because the remaining portion of the scheduling interval is too short, i.e. the remaining portion of the scheduling interval is shorter than a transmission duration threshold.

The primary/secondary users of a TWT SP may be also a group of STAs, e.g. several non-AP STAs are allocated as primary and/or secondary users.

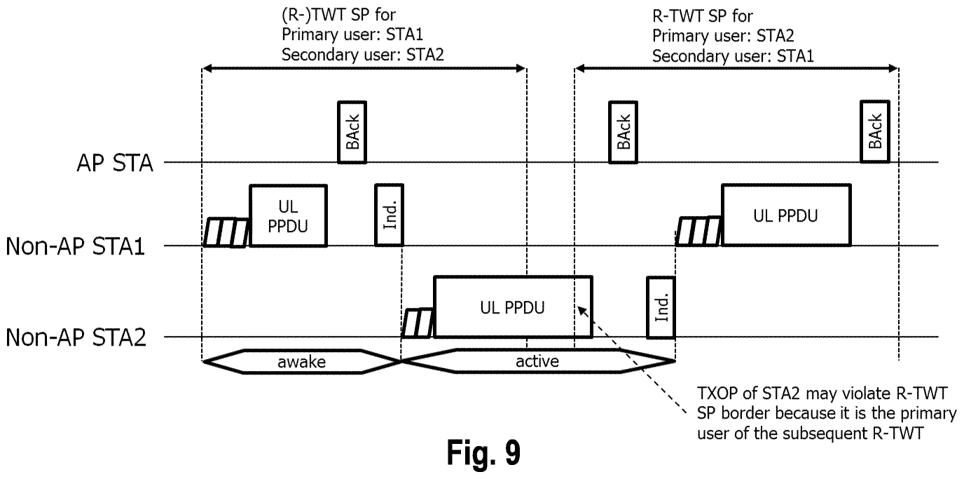

Any STA that obtained a TXOP may continue its TXOP, according to limitations by regulatory bodies, after the TWT SP ended, unless it is followed by another R-TWT SP. If the STA that is currently transmitting the TXOP belongs to the primary user of the following R-TWT SP with which it would overlap, it may continue its TXOP as shown in FIG. 9 illustrating a second embodiment of a communication scheme according to the present disclosure. In this regard, the rule for R-TWT that any STA shall end its TXOP at its beginning is weakened.

Since the remaining time of a TWT SP that a secondary user may get depends on the primary user's data transfer, the secondary user's traffic should be rather of type best effort than low latency for example, because the amount of remaining time is unpredictable and underlies high variance. This is illustrated in FIG. 8 when comparing the TWT SP on the left hand side with the TWT SP on the right hand side.

In an embodiment the primary/secondary user assignment may also come with a recommendation of the traffic type or data priority to be transmitted. The priority may be given by traffic identifiers (TID) that also determine the EDCA parameters to be used by a STA for channel access.

In an application scenario according to the embodiment shown in FIG. 8 the primary users get assigned high priority traffic, e.g. TIDs that are assigned to access category of voice (AC_VO), whereas secondary users get assigned low priority traffic, e.g. TIDs that are assigned to access category of best effort (AC_BE) or background (AC_BK).

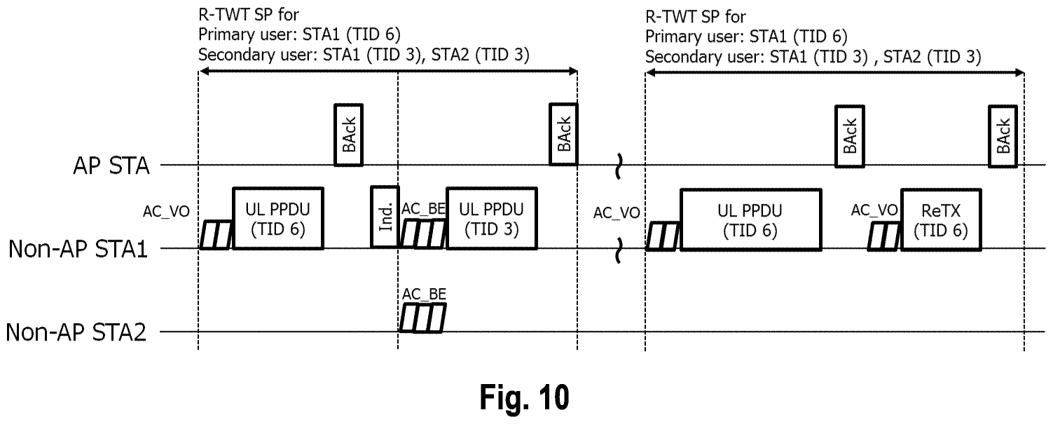

In another embodiment primary and secondary user are the same user but have different preferred TIDs. The TID recommendation sticks to the TWT setup and is thus independent of the applied channel access mechanism. Thereby, the high priority traffic may often be rather assigned to primary user than secondary user. FIG. 10 shows a diagram of another embodiment of a communication scheme according to the present disclosure that illustrates operation in which there are two traffic priorities: TID 6 that is mapped to the access category (AC) of voice (AC_VO) and TID 3 that is mapped to AC of best effort (BE), i.e. AC_BE. The secondary non-AP STAs may access the channel when non-AP STA1 has sent the indication frame to release the TWT once it has transmitted all traffic of priority TID 6 to the AP. After the TWT was released, non-AP STA1 wins the contention for channel access over non-AP STA2 and transmits traffic of priority TID 3.

The design of the TWT SP release indication is important, because it is essential for secondary user STAs to understand that they may access the channel, i.e., that they may contend for channel access and/or perform data communication with the AP STA.

In the following, different cases are differentiated in which there is one primary STA and cases in which there are multiple primary STAs. Some of the following embodiments (e.g. following option c) work for both cases. A “single primary STA”, STA A, implies a unidirectional traffic, i.e., a data transmission from STA A to STA B (e.g. AP STA) with Ack or BAck (both herein referred to as “acknowledgement”) in reverse direction. Thus, a bidirectional data transfer between AP and STA, which relies on separately initiated TXOPs in each direction, is to be considered under multiple primary STAs, i.e. options c, d or e. In contrast, a bidirectional data transfer that can work with a TXOP initiated by a single STA, i.e. using reverse direction grant (RDG) mechanism, may be considered as single primary STA.

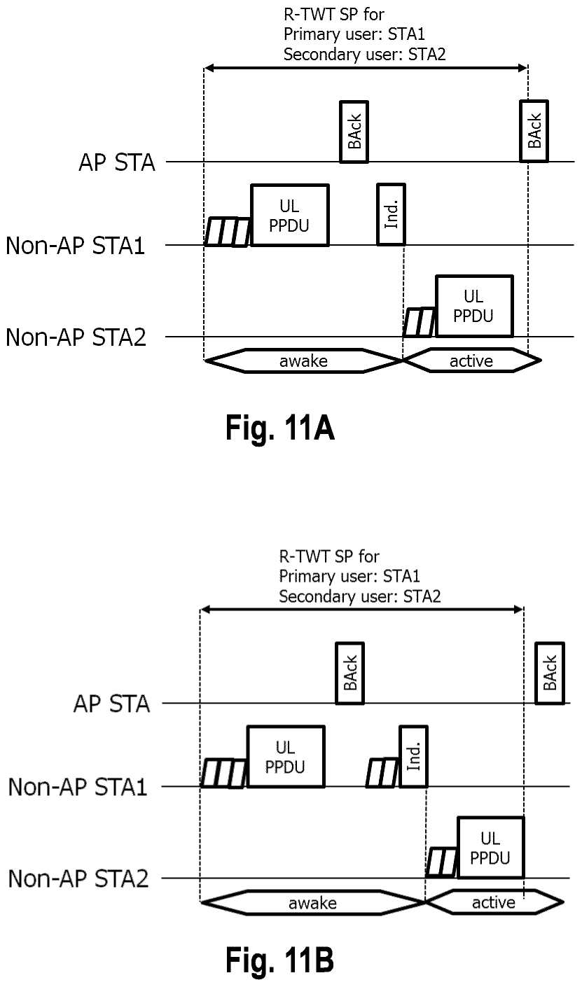

In an embodiment (option a) an explicit TWT release indication is provided by means of a frame that is sent by the primary user STA once it successfully finished its data transfer of the recommended TID, if applicable. This frame may be sent in existing TXOP that is established between primary STA and its peer STA (the AP STA) or in a separate, newly initiated TXOP between primary STA and all secondary user STAs. A newly initiated TXOP may be of the type broadcast too. FIG. 11 shows diagrams that illustrate both cases: According to the embodiment shown in FIG. 11A the indication frame is transmitted in the same TXOP, whereas in the embodiment shown in FIG. 11B the indication is transmitted in a newly established TXOP.

If there is only a single secondary user STA, the secondary user STA may acknowledge the indication frame from the primary user STA in case of a newly initiated TXOP. The release indication transmitted as described above requires primary and secondary users to be non-hidden, i.e., the primary STA should select a modulation coding scheme (MCS) such that all secondary STAs can understand the release indication. If this is not possible, e.g. because the communication distance is too large, the solution elaborated below (as option d) is applicable.

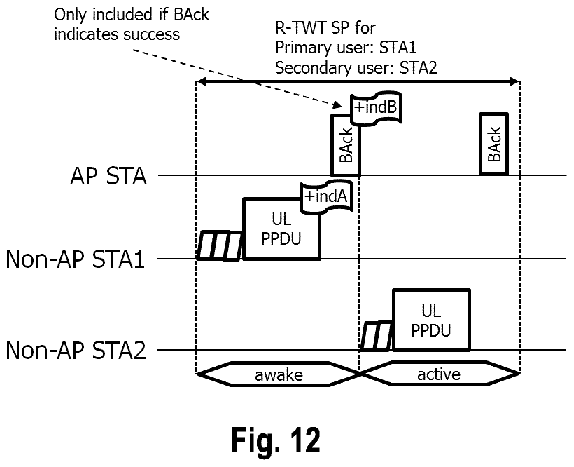

According to another embodiment (option b) a release indication may be contained within a data transmission, e.g. within the PHY or MAC header or as a frame aggregated to the data frame, of at least the last frame being transmitted by the primary user STA. Since the primary user STA is not aware of a successful reception at its peer STA at the point in time of transmission, the peer STA repeats this information in the Acknowledgement (Ack) or Block Ack (BAck) if the transmission was successful and/or the transmission did not have more errors than a predefined threshold (“error threshold”), e.g. a relative threshold indicating the maximum percentage of erroneously received data units (e.g. 10%). A secondary user STA accesses the medium only, if it received the release indication within a PPDU sent by the peer STA (AP STA in FIG. 12) which can be readily determined from the e.g. MAC header. FIG. 12 illustrates the envisioned operation: Non-AP STA1 includes an indication A (indA, also referred to as first release indication) that indicates that it may release the TWT if the AP STA acknowledges successful data reception. The AP STA indicates if the BAck acknowledges successful data reception by an indication B (indB, also referred to as second release indication) that the TWT is released. The content of indA and indB may be similar or the same, but logically they are two different indications, because only indB finally releases the TWT, whereas indA is a conditional release indication that targets the peer STA (AP STA in FIG. 12) only. This mode of indication has the advantage that the AP STA can reach any secondary user STA within its BSS if the MCS is set appropriately. Since Ack or BAck frames have a low MCS anyway, this has only minor impact on the overall transmission time.

In another embodiment the indication indA may be seen as a buffer status report that is included in MAC header of several frames. If a transmitting STA indicates an empty buffer or queue for the TID that is allowed for data transfer in a TWT SP, the AP STA may consider this as an indication that the TWT can be released conditional to BAck response. From non-AP STA point of view, it shall not set this buffer status to zero unless it would like to release the TWT.

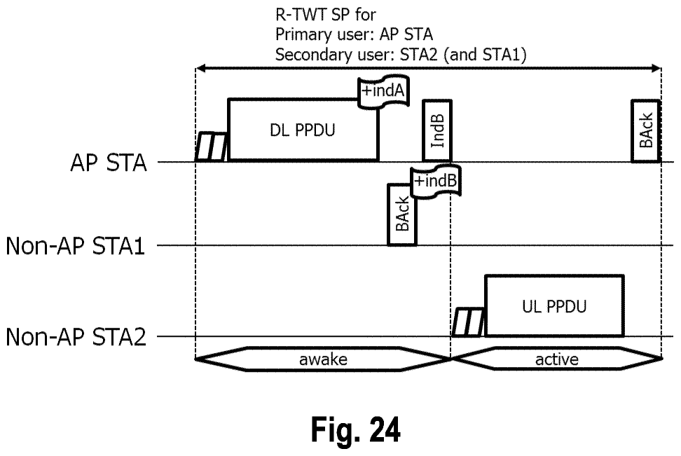

If the peer STA is not an AP STA, e.g. the AP STA transmits to a non-AP STA and BAck is provided by a non-AP STA, the AP STA may need to repeat the TWT release indication (similar to option d below) to avoid a hidden node issue. In this case the AP STA transmits and indA, followed by an indB sent by non-AP STA. The AP subsequently repeats the indB indication. This embodiment is illustrated in FIG. 24.

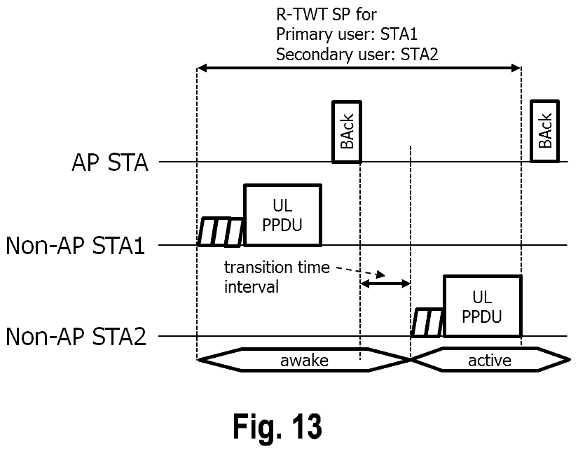

A TWT release indication can also be implicitly present as provided according to another embodiment (option c). Thereby the TWT requester and responder agree on a transition time that defines a maximum inactivity interval in which a primary user STA does not access the channel, before the TWT is automatically released to secondary STAs. FIG. 13 illustrates this mode of operation: A secondary user STA that does not observe a PPDU from the primary STAs and AP STA for a time interval larger or equal to the maximum inactivity interval may access the channel. Thereby, regular channel access rules apply, i.e., the secondary STAs shall respect any non-zero NAV timer such that a secondary user STA does not access the channel within an established TXOP. In this sense, the mechanism is hidden-node proof, i.e., an RTS-CTS exchange between primary and secondary user STA may be adequate.

With multiple primary STAs, the issue exists that only after all primary user STAs finished their data transfer, the one or more secondary user STAs may access the TWT SP. Except for option c, the options mentioned before may be modified to cover the case of multiple primary user STAs.

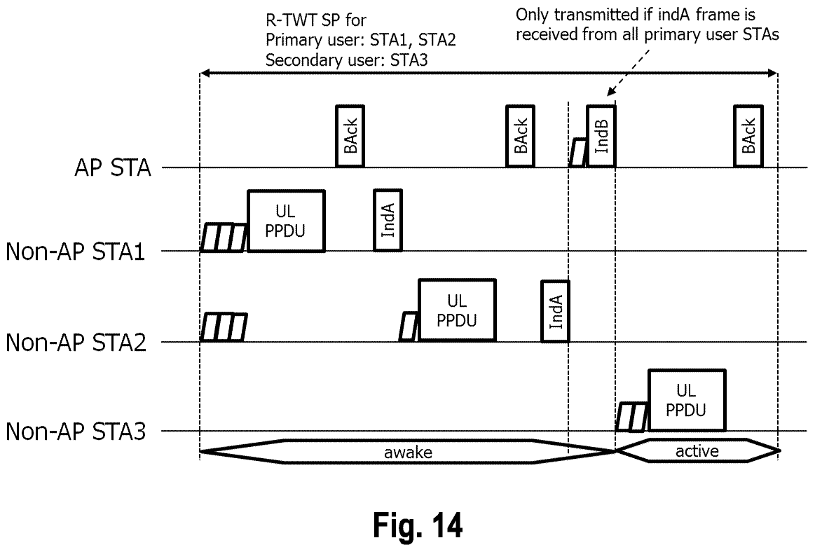

An embodiment (option d) for use with multiple primary STAs is based on options a and b: Each primary user STA transmits a TWT release indication that is directed to the AP STA. The AP STA records the status of each primary user STA, i.e., if each primary STA has successfully ended its data transfer. Once the AP STA noted that all primary STAs have sent a release indication of type IndA, it transmits a TWT release indication frame of type IndB to all secondary user STAs. If the indication is a separate frame (like option a), it may need to initiate a separate TXOP (as shown in FIG. 14 that illustrates the operation based on indication frames), unless the last primary STA hands over the TXOP ownership to the AP STA in the sense of a reverse direction protocol.

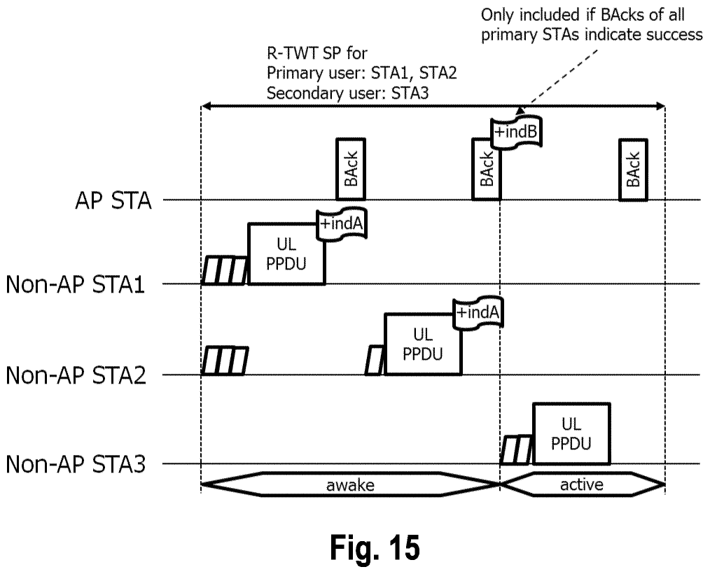

If the indication resides within a data or response frame (like option b), the AP STA releases the TWT only after all primary STAs have successfully finished their data transfer. In other words, the AP STA includes, in the last response frame to the data transferred from the last primary STA that did not finish its data transfer yet, a TWT release indication. FIG. 15 illustrates the operation for this variant.

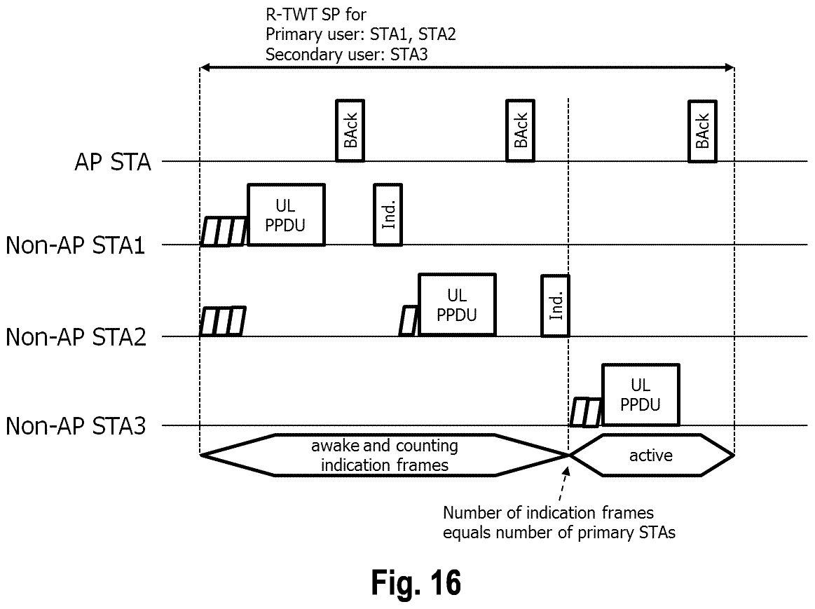

In another embodiment illustrated in FIG. 16, a secondary user STA may only transmit if it received a number of release indications equal to the number of primary STAs. This requires, however, that the primary user STAs are not hidden to the secondary STAs such that all TWT release indications are received by the secondary user STAs as shown in FIG. 16 illustrating another embodiment of a communication scheme (option e). Optionally, the AP may count the number of release indications and include this information (and/or the number of primary STAs) into its frames for secondary user STAs to retrieve this information. This may help to avoid the hidden node problem. The Ind frames in FIG. 16 are of type IndB.

In the following the tasks of the primary and secondary user STAs and of the AP STA are summarized.

A primary non-AP STA is awake at least during the TWT SP of which it is primary user until it released the TWT to secondary user STAs. It may access the channel by EDCA at any point during the TWT of which it is primary user (preferably it should initiate channel access the channel right after the TWT begins). If the TWT is trigger-enabled a STA should await a trigger from AP STA. Further, it should send a TWT release indication according to the mechanisms described above once it successfully finished its data transfer unless the TWT duration is close to its end. It may continue channel access by EDCA after the TWT has been released.

A secondary non-AP STA is awake at least during the TWT SP of which it is secondary user unless it has no data to transmit and the AP indicated that no downlink data is to be delivered to the STA within the TWT SP. Such an indication by the AP may reside in a beacon frame before the TWT SP or within the TWT release indication or within a separate announcement by the AP at the beginning of the TWT SP. Further, it should observe the channel and listen for TWT release indication(s), and it should not access the channel by EDCA unless it received a TWT release indication in the sense described above, e.g. it may also receive multiple TWT release indications before it may access the channel by EDCA.

An AP STA (according to the behavior described below, the AP STA acts like a primary user non-AP STA is awake at any time (this is its regular behavior) and may access the channel by EDCA to initiate a TXOP with primary user STAs at any time during the TWT SP, which implies for TB access that the AP may send a trigger frame to primary users at any time during the TWT SP. Further, it should not access the channel by EDCA to initiate a TXOP with a secondary user STA unless the TWT SP has been released, which implies for TB access that the AP STA should not send a trigger frame to secondary user STAs before the TWT was not released to secondary user STAs or before the AP STA received not all related indications from non-AP STAs, indicating that the TWT is released. The AP STA may initiate a TXOP with a primary or secondary user STA after the TWT SP has been released, which implies for TB access that the AP STA may send a trigger frame to primary and/or secondary user STAs after the TWT was released to secondary users STAs. The AP STA shall further participate in TWT release indication as described above if needed.

Besides that, all STAs participate in a frame exchange that configures the TWT, i.e. request TWT membership and/or respond to TWT requests. During these frame exchanges the primary/secondary users are set for a TWT SP.

Regarding the signaling which defines who is primary and/or secondary user, two embodiments may be considered that affect the role of the AP. As described in the AP behavior above, the AP acts similar to a primary user STA. Since an AP STA acts always the same it may or may not be defined explicitly as a primary user. In case it is not explicitly defined in a TWT setup, TWT setups may exists that have no primary user. In those TWT SPs, the AP STA is the only STA that may initiate TXOP with non-AP STAs, i.e., downlink traffic is mainly present.

Since the channel access for primary and secondary users may be different, e.g. trigger based for primary user STAs and EDCA for secondary user STAs, TB access for both, or EDCA for both, the type of channel access should be also signaled within the setup of the TWT.

The examples shown above relate to distributed channel access. For the sake of completeness, explanations and figures are provided below that illustrate operation for trigger-based (TB) channel access.

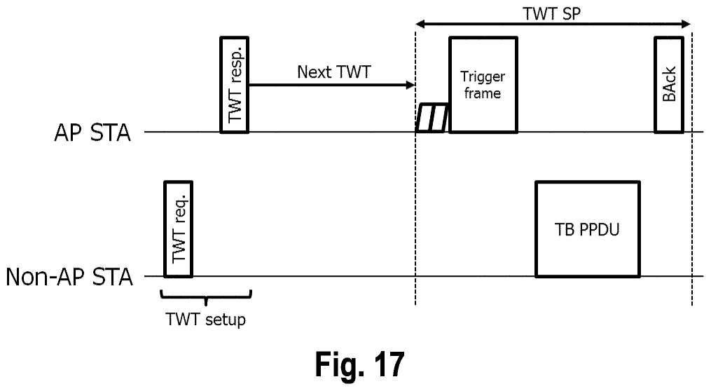

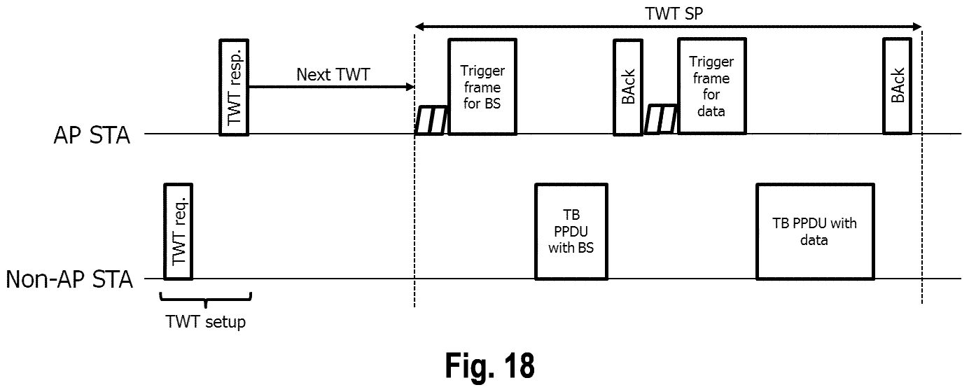

FIG. 17 shows a diagram of a known TB-enabled TWT. Within the TB-enabled TWT, the AP should trigger the STAs that are part of the TWT SP. Once triggered one or more STAs transmit SIFS after the trigger frame a TB PPDU on the resource unit defined in the trigger frame as a response to the trigger frame. The TB PPDU is followed by a BAck sent by AP. In order for the AP to determine the required length of the TB PPDU, the AP should send a trigger frame followed by a short TB PPDU that includes buffer status (BS) beforehand. This is illustrated in FIG. 18.

In contrast to channel access by EDCA, pure TB access TWT does not need the indications for TWT release, because the operation is coordinated by the AP STA. The AP STA applies EDCA to obtain a TXOP that contains the trigger frame. Therefore, a pure TB access TWT is defined by the AP STA using EDCA but the non-AP STAs are not. However, non-AP STAs may or may not check the medium status, i.e. busy or idle, before transmitting TB PPDU.

Also, since the AP STA should request the BS of non-AP STAs before it is triggering the data transfer, it is aware of the data length to be transmitted. As the AP STA sets within the trigger frame transmission parameters such as BW and MCS that the non-AP STA needs to apply in TB PPDU, the AP STA can calculate the duration of the TB PPDU such that all buffered data of the non-AP STA can be transferred. In addition, the AP STA is aware of any retransmissions that may be needed for successful data delivery. To summarize, the AP STA has all information it needs to release the TWT to secondary STA. If the secondary STAs perform pure TB-based access too, the release indication may be dropped, or it is implicitly present in the trigger frame that triggers secondary users STAs on top of primary user STAs.

As soon as EDCA is applied in the TWT by at least one non-AP STA, TWT release indications shall be present for those STAs to understand when the TWT is released.

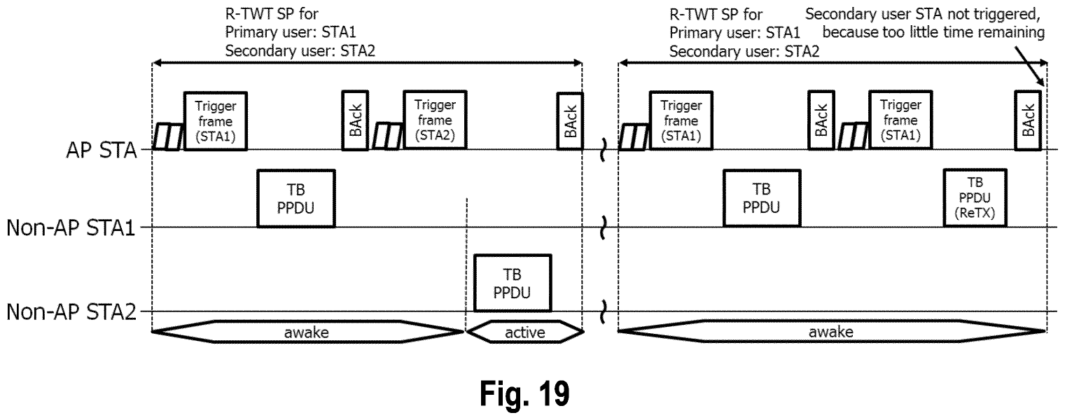

FIG. 19 left hand side illustrates TB access operation for the same scenario as shown in FIG. 8. It is assumed that BS is already known by AP STA. In general, a trigger frame may request multiple non-AP STAs to transmit TB PPDU at the same time. Those TB PPDUs are differentiated by frequency and/or space. This degree of freedom may be exploited by the AP to trigger in a second trigger frame not only STA1 for retransmission as shown in FIG. 19 right hand side, but also to trigger STA2 at the same time (not shown in FIG. 19). However, the duration of a PPDU multiplex over frequency requires more transmit time compared to the case of a single TB PPDU being sent; hence, PPDU multiplex may not be a preferred choice for latency sensitive traffic in the considered scenario.

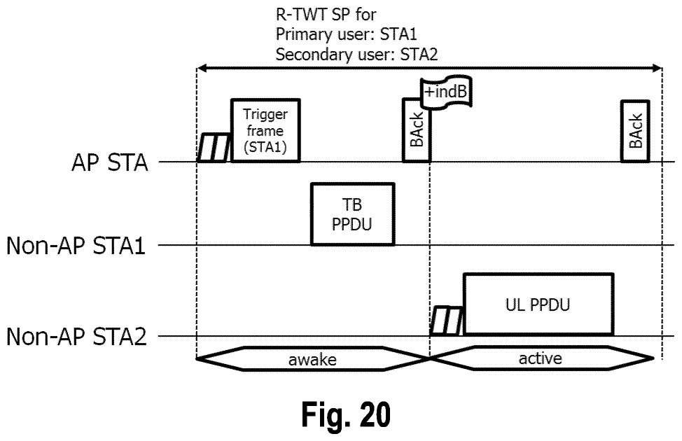

FIG. 20 shows an embodiment of a scenario with mixed channel access mechanisms for primary and secondary user STAs. Primary user STAs use TB-access whereas secondary user STAs use EDCA. In such a case, the AP transmits a TWT release indication right after or as part of the successful response to TB PPDUs. The scenario is closely related to the scenario shown in FIG. 12, however the indA indication is dropped here because it is assumed that the AP is aware of non-AP STA1's buffer status. If this is not the case, indA indication may be added to the TB PPDU of non-AP STA1.

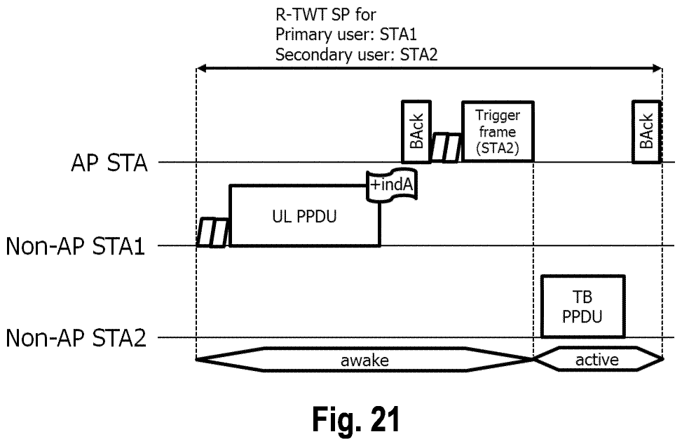

FIG. 21 shows an embodiment of a scenario with mixed channel access mechanisms in which the primary user STAs use EDCA and secondary users use TB-access. The non-AP STA1 releases the TWT to secondary user by an indA indication, after which the AP starts to trigger the secondary user STAs, here non-AP STA2 for it to transmit its TB PPDU.

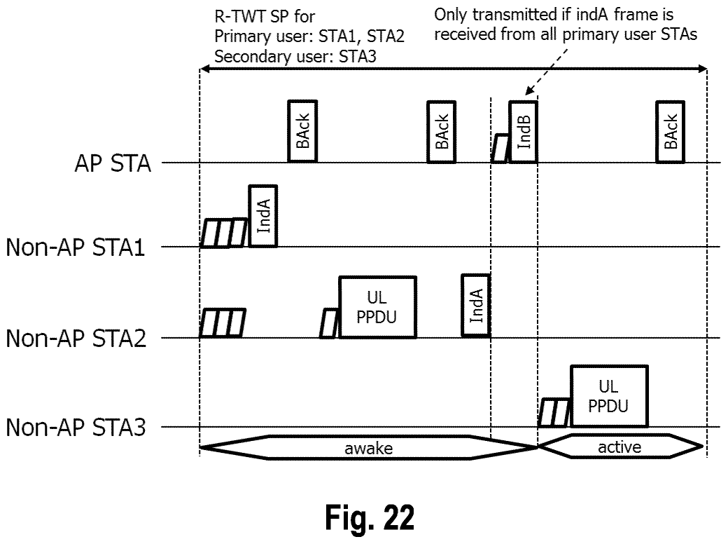

Another consideration is the case in which a primary user STA has no data to transmit. Naturally, it would not send any data. However, in the context of the present disclosure it may be considered useful for primary STAs and provided in an embodiment to transmit the TWT release indication of type indA to avoid the secondary user STAs not to access the channel as illustrated in FIG. 22. It shall be noted that this does not apply for implementation option c in which case the secondary user STAs are going to access the medium after a certain time.

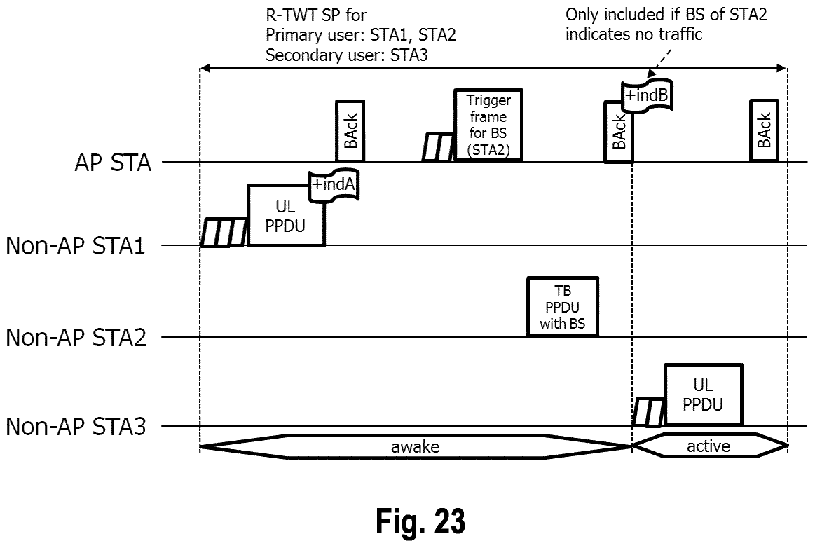

In case the AP is missing a response by primary user non-AP STA, it may query the buffer status of these primary user non-AP STAs. If they do not respond or if they indicate an empty buffer, the AP may release the TWT to secondary user STAs by indication of type indB as illustrated in FIG. 23. It should be noted that some transmission pause may be present between transmission of primary user non-AP STAs due to the random backoff. Thus, it depends on the impatience of the AP STA when to trigger a buffer status report.

Thus, as particularly illustrated in FIGS. 20 to 23, the AP STA may
i) receive a first release indication from the first communication device indicating that the first communication device has finished data exchange with the third communication device during the scheduling interval and transmit a second release indication indicating that the remaining portion of the scheduling interval is released for use by a second communication device, the second communication device being a secondary user of the scheduling interval, or
ii) transmit a first release indication indicating that the third communication device has finished data communication with the first communication device during the scheduling interval, receive a second release indication from the first communication device indicating that the remaining portion of the scheduling interval is released for use by a second communication device, and repeating the transmission of the second release indication, or
iii) transmit a second release indication or other information indicating or allowing a second communication device to determined that the remaining portion of the scheduling interval is released for use by a second communication device.

According to case iii) the AP STA may send some special information such that secondary users know that the primary users have finished data communication (preferably, they should know the number of primary users beforehand, and that secondary users should stay awake or some countdown information). This special information may be considered as a kind of second release information, but in this case this is supporting information that is transmitted before the exchange between AP STA and the primary user is done. In case of countdown information, once a primary user starts a transmission, within the AP responses there is a countdown decrement, secondary users hear at least the release from primary users or the countdown. This can be a protection against primary users that can be hidden with respect to secondary users.

The present disclosure provides for an efficient use of transmit time in a scheduled transmission time interval for data transmissions with high variance in duration. Further, signaling is used among STAs to determine end of medium usage by a primary user STA and distributed, trigger-based, and mixed channel access is supported.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriated circuits. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit includes the above-described hardware executing software.

It follows a list of further embodiments of the disclosed subject matter:

1. First communication device configured to communicate with a third communication device, the first communication device comprising circuitry configured to
perform data exchange with the third communication device during a first portion of a scheduling interval, wherein data exchange between the first and the third communication device is planned during the scheduling interval, the first communication device being a primary user of the scheduling interval; and
transmit a release indication indicating that the remaining portion of the scheduling interval is released for use by a second communication device, the second communication device being a secondary user of the scheduling interval.

2. First communication device as defined in embodiment 1,
wherein the circuitry is further configured to transmit the release indication after the first communication device has finished data exchange with the third communication device or has empty transmit buffer.

3. First communication device a defined in any one of the preceding embodiments,
wherein the circuitry is further configured to transmit the release indication after reception of an acknowledgement of data reception from the third communication device or after reception of a release indication from the third communication device indicating that the third communication device has finished data exchange with the first communication device.

4. First communication device as defined in any one of the preceding embodiments,
wherein the circuitry is further configured to transmit the release indication as groupcast or broadcast.

5. First communication device as defined in any one of the preceding embodiments,
wherein the circuitry is further configured to refrain from transmitting a release indication if the remaining portion of the scheduling interval is shorter than a transmission duration threshold.

6. First communication device as defined in any one of the preceding embodiments,
wherein the circuitry is further configured to transmit the release indication in an existing transmission opportunity established between the first communication device and the third communication device.

7. First communication device as defined in any one of the preceding embodiments,
wherein the circuitry is further configured to transmit the release indication in a new transmission opportunity newly established between the first communication device and the second and/or third communication devices.

8. First communication device as defined in any one of the preceding embodiments,
wherein the circuitry is further configured to transmit the release indication as part of data or control information transmitted to the third communication device.

9. First communication device as defined in embodiment 8,
wherein the circuitry is further configured to transmit the release indication as part of a PHY header, or as part of a MAC header, or as frame aggregated to a data frame, or as last data frame, or as part of a buffer status report.

10. First communication device as defined in any one of the preceding embodiments,
wherein the circuitry is further configured to only access the channel by responding to the third communication device after a trigger frame has been received from the third communication device which specifies the first communication device as a responder.

11. First communication device as defined in any one of the preceding embodiments,
wherein different priorities are assigned to different pieces of data to be transmitted by the first communication device and
wherein the circuitry is further configured to
   transmit a release indication after the transmission of first pieces of data having a high priority has been finished and
   contend for channel access for the transmission of second pieces of data having a lower priority than the first pieces of data.

12. First communication device as defined in any one of the preceding embodiments,
wherein the circuitry is further configured to refrain from transmitting any data during the remaining portion of the scheduling interval.

13. Second communication device configured to communicate with a third communication device, the second communication device comprising circuitry configured to
stay awake during a scheduling interval, wherein data exchange between the third communication device and a first communication device is planned during the scheduling interval, the first communication device being a primary user of the scheduling interval and the second communication device being a secondary user of the scheduling interval;
listen to a release indication indicating that the remaining portion of the scheduling interval is released for use by the second communication device; and
contend for channel access and/or perform data exchange with the third communication device during at least the remaining portion of the scheduling interval if
i) a release indication is received or
ii) no data exchange between the first communication device and the third communication device is observed for at least an inactivity interval.

14. Second communication device as defined in embodiment 13,
wherein the circuitry is further configured to start contending for channel access and/or performing data exchange with the third communication device during the remaining portion of the scheduling interval only if the release indication has been received from the first or third communication device.

15. Second communication device as defined in any one of embodiments 13 to 14,
wherein the circuitry is further configured to continue data exchange with the third communication device beyond the current scheduling interval, if it is a primary user of the subsequent scheduling interval or if there is no overlap with a subsequent scheduling interval of which the second communication device it is not a primary user.

16. Second communication device as defined in any one of embodiments 13 to 15,
wherein data exchange of the third communication device with multiple first communication devices is planned during the scheduling interval, the first communication devices all being primary users of the scheduling interval, and
wherein the circuitry is further configured to
   receive a primary user number indication indicating the number of primary users and/or a release number indication indicating from how many first communication devices the third communication device has already received a release indication; and
   start contending for channel access and/or performing data exchange with the third communication device during at least the remaining portion of the scheduling interval only if a release indication has been received from all first communication devices or from the third communication device.

17. Second communication device as defined in any one of embodiments 13 to 16,
wherein the circuitry is further configured to refrain from or stop listening to a release indication if it has no data to transmit and if the third communication device indicated that it has no data to transmit to the second communication device.

18. Second communication device as defined in any one of embodiments 13 to 17,
wherein the circuitry is further configured to only access the channel by responding to the third communication device after a trigger has been received from the third communication device which specifies at least the second communication device as a responder.

19. Third communication device configured to communicate with a first and/or second communication device, the third communication device comprising circuitry configured to
perform data exchange with the first communication device during a first portion of a scheduling interval, wherein data exchange between the third communication device and the first communication device is planned during the scheduling interval, the first communication device being a primary user of the scheduling interval; and
i) receive a first release indication from the first communication device indicating that the first communication device has finished data exchange with the third communication device during the scheduling interval and transmit a second release indication indicating that the remaining portion of the scheduling interval is released for use by a second communication device, the second communication device being a secondary user of the scheduling interval, or
ii) transmit a first release indication indicating that the third communication device has finished data exchange with the first communication device during the scheduling interval, receive a second release indication from the first communication device indicating that the remaining portion of the scheduling interval is released for use by a second communication device, and repeat the transmission of the second release indication, or
iii) transmit a second release indication or other information indicating or allowing a second communication device to determine that the remaining portion of the scheduling interval is released for use by a second communication device.

20. Third communication device as defined in embodiment 19,
wherein the circuitry is further configured to transmit the second release indication as part of an acknowledgement.

21. Third communication device as defined in any one of embodiments 19 to 20,
wherein the circuitry is further configured to transmit the second release indication only if the data transmitted by the first communication device have been received without errors or with errors below an error threshold.

22. Third communication device as defined in any one of embodiments 19 to 21,
wherein data exchange of the third communication device with multiple first communication devices is planned during the scheduling interval, the first communication devices all being primary users of the scheduling interval, and
wherein the circuitry is further configured to transmit the second release indication only if a first release indication has been received from all first communication devices.

23. Third communication device as defined in any one of embodiments 19 to 22,
wherein data exchange of the third communication device with multiple first communication devices is planned during the scheduling interval, the first communication devices all being primary users of the scheduling interval, and
wherein the circuitry is further configured to transmit a primary user number indication indicating the number of primary users and/or a release number indication indicating from how many first communication devices a release indication has already been received.

24. Third communication device as defined in any one of embodiments 19 to 23,
wherein the circuitry is further configured to transmit a trigger frame, representing the second release indication, to a first or second communication device to initiate data transfer as a response to the trigger from the first or second communication device to the third communication device, the first or second communication device being identified by the information contained in the trigger frame.

25. Third communication device as defined in any one of embodiments 19 to 24,
wherein the circuitry is further configured to indicate to communication devices if a communication device is a primary user or a secondary user.

26. Third communication device as defined in embodiment 25,
wherein the circuitry is further configured to transmit the indication if a communication device is a primary user or a secondary user as part of the configuration of the scheduling interval.

27. First communication method of a first communication device configured to communicate with a third communication device, the first communication method comprising
performing data exchange with the third communication device during a first portion of a scheduling interval, wherein data exchange between the first and the third communication device is planned during the scheduling interval, the first communication device being a primary user of the scheduling interval; and
transmitting a release indication indicating that the remaining portion of the scheduling interval is released for use by a second communication device, the second communication device being a secondary user of the scheduling interval.

28. Second communication method of a second communication device configured to communicate with a third communication device, the second communication method comprising
staying awake during a scheduling interval, wherein data exchange between the third communication device and a first communication device is planned during the scheduling interval, the first communication device being a primary user of the scheduling interval and the second communication device being a secondary user of the scheduling interval;
listening to a release indication indicating that the remaining portion of the scheduling interval is released for use by the second communication device; and
contending for channel access and/or performing data exchange with the third communication device during at least the remaining portion of the scheduling interval if
i) a release indication is received or
ii) no data exchange between the first communication device and the third communication device is observed for at least an inactivity interval.

29. Third communication method of a third communication device configured to communicate with a first and/or second communication device, the third communication method comprising
performing data exchange with the first communication device during a first portion of a scheduling interval, wherein data exchange between the third communication device and the first communication device is planned during the scheduling interval, the first communication device being a primary user of the scheduling interval; and
i) receiving a first release indication from the first communication device indicating that the first communication device has finished data exchange with the third communication device during the scheduling interval and transmitting a second release indication indicating that the remaining portion of the scheduling interval is released for use by a second communication device, the second communication device being a secondary user of the scheduling interval, or
ii) transmitting a first release indication indicating that the third communication device has finished data exchange with the first communication device during the scheduling interval, receiving a second release indication from the first communication device indicating that the remaining portion of the scheduling interval is released for use by a second communication device, and repeating the transmission of the second release indication, or
iii) transmitting a second release indication or other information indicating or allowing a second communication device to determine that the remaining portion of the scheduling interval is released for use by a second communication device.

30. A non-transitory computer-readable recording medium that stores therein a computer program product, which, when executed by a processor, causes the method according to embodiment 27, 28 or 29 to be performed.

31. A computer program comprising program code means for causing a computer to perform the steps of said method according to embodiment 27, 28 or 29 when said computer pro-gram is carried out on a computer.

1. First communication device configured to communicate with a third communication device, the first communication device comprising circuitry configured to
perform data exchange with the third communication device during a first portion of a scheduling interval, wherein data exchange between the first and the third communication device is planned during the scheduling interval, the first communication device being a primary user of the scheduling interval; and
transmit a release indication indicating that the remaining portion of the scheduling interval is released for use by a second communication device, the second communication device being a secondary user of the scheduling interval.

2. First communication device as claimed in claim 1,
wherein the circuitry is further configured to transmit the release indication after the first communication device has finished data exchange with the third communication device or has empty transmit buffer, and/or to transmit the release indication after reception of an acknowledgement of data reception from the third communication device or after reception of a release indication from the third communication device indicating that the third communication device has finished data exchange with the first communication device.

3. First communication device as claimed in claim 1,
wherein the circuitry is further configured to refrain from transmitting a release indication if the remaining portion of the scheduling interval is shorter than a transmission duration threshold and/or to refrain from transmitting any data during the remaining portion of the scheduling interval.

4. First communication device as claimed in claim 1,
wherein the circuitry is further configured to transmit the release indication in an existing transmission opportunity established between the first communication device and the third communication device or in a new transmission opportunity newly established between the first communication device and the second and/or third communication devices.

5. First communication device as claimed in claim 1,
wherein the circuitry is further configured to transmit the release indication, transmitted to the third communication device, as part of data, or as part of control information, or, as part of a PHY header, or as part of a MAC header, or as frame aggregated to a data frame, or as last data frame, or as part of a buffer status report.

6. First communication device as claimed in claim 1,
wherein the circuitry is further configured to only access the channel by responding to the third communication device after a trigger frame has been received from the third communication device which specifies the first communication device as a responder.

7. First communication device as claimed in claim 1,
wherein different priorities are assigned to different pieces of data to be transmitted by the first communication device and
wherein the circuitry is further configured to
transmit a release indication after the transmission of first pieces of data having a high priority has been finished and
contend for channel access for the transmission of second pieces of data having a lower priority than the first pieces of data.

8. Second communication device configured to communicate with a third communication device, the second communication device comprising circuitry configured to
stay awake during a scheduling interval, wherein data exchange between the third communication device and a first communication device is planned during the scheduling interval, the first communication device being a primary user of the scheduling interval and the second communication device being a secondary user of the scheduling interval;
listen to a release indication indicating that the remaining portion of the scheduling interval is released for use by the second communication device; and
contend for channel access and/or perform data exchange with the third communication device during at least the remaining portion of the scheduling interval if
i) a release indication is received or
ii) no data exchange between the first communication device and the third communication device is observed for at least an inactivity interval.

9. Second communication device as claimed in claim 8,
wherein the circuitry is further configured
to start contending for channel access and/or performing data exchange with the third communication device during the remaining portion of the scheduling interval only if the release indication has been received from the first or third communication device, and/or
to continue data exchange with the third communication device beyond the current scheduling interval, if it is a primary user of the subsequent scheduling interval or if there is no overlap with a subsequent scheduling interval of which the second communication device it is not a primary user.

10. Second communication device as claimed in claim 8,
wherein data exchange of the third communication device with multiple first communication devices is planned during the scheduling interval, the first communication devices all being primary users of the scheduling interval, and
wherein the circuitry is further configured to
receive a primary user number indication indicating the number of primary users and/or a release number indication indicating from how many first communication devices the third communication device has already received a release indication; and
start contending for channel access and/or performing data exchange with the third communication device during at least the remaining portion of the scheduling interval only if a release indication has been received from all first communication devices or from the third communication device.

11. Second communication device as claimed in claim 8,
wherein the circuitry is further configured to refrain from or stop listening to a release indication if it has no data to transmit and if the third communication device indicated that it has no data to transmit to the second communication device, and/or to only access the channel by responding to the third communication device after a trigger has been received from the third communication device which specifies at least the second communication device as a responder.

12. Third communication device configured to communicate with a first and/or second communication device, the third communication device comprising circuitry configured to
perform data exchange with the first communication device during a first portion of a scheduling interval, wherein data exchange between the third communication device and the first communication device is planned during the scheduling interval, the first communication device being a primary user of the scheduling interval; and
i) receive a first release indication from the first communication device indicating that the first communication device has finished data exchange with the third communication device during the scheduling interval and transmit a second release indication indicating that the remaining portion of the scheduling interval is released for use by a second communication device, the second communication device being a secondary user of the scheduling interval, or
ii) transmit a first release indication indicating that the third communication device has finished data exchange with the first communication device during the scheduling interval, receive a second release indication from the first communication device indicating that the remaining portion of the scheduling interval is released for use by a second communication device, and repeat the transmission of the second release indication, or
iii) transmit a second release indication or other information indicating or allowing a second communication device to determine that the remaining portion of the scheduling interval is released for use by a second communication device.

13. Third communication device as claimed in claim 12,
wherein the circuitry is further configured to transmit the second release indication as part of an acknowledgement and/or to transmit the second release indication only if the data transmitted by the first communication device have been received without errors or with errors below an error threshold.

14. Third communication device as claimed in claim 12,
wherein data exchange of the third communication device with multiple first communication devices is planned during the scheduling interval, the first communication devices all being primary users of the scheduling interval, and
wherein the circuitry is further configured to transmit the second release indication only if a first release indication has been received from all first communication devices.

15. Third communication device as claimed in claim 12,
wherein data exchange of the third communication device with multiple first communication devices is planned during the scheduling interval, the first communication devices all being primary users of the scheduling interval, and wherein the circuitry is further configured to transmit a primary user number indication indicating the number of primary users and/or a release number indication indicating from how many first communication devices a release indication has already been received, and/or
wherein the circuitry is further configured to transmit a trigger frame, representing the second release indication, to a first or second communication device to initiate data transfer as a response to the trigger from the first or second communication device to the third communication device, the first or second communication device being identified by the information contained in the trigger frame.

16. Third communication device as claimed in claim 12,
wherein the circuitry is further configured to indicate to communication devices if a communication device is a primary user or a secondary user and/or to transmit an indication if a communication device is a primary user or a secondary user as part of the configuration of the scheduling interval.

17. First communication method of a first communication device configured to communicate with a third communication device, the first communication method comprising
performing data exchange with the third communication device during a first portion of a scheduling interval, wherein data exchange between the first and the third communication device is planned during the scheduling interval, the first communication device being a primary user of the scheduling interval; and
transmitting a release indication indicating that the remaining portion of the scheduling interval is released for use by a second communication device, the second communication device being a secondary user of the scheduling interval.

18. Second communication method of a second communication device configured to communicate with a third communication device, the second communication method comprising
staying awake during a scheduling interval, wherein data exchange between the third communication device and a first communication device is planned during the scheduling interval, the first communication device being a primary user of the scheduling interval and the second communication device being a secondary user of the scheduling interval;
listening to a release indication indicating that the remaining portion of the scheduling interval is released for use by the second communication device; and
contending for channel access and/or performing data exchange with the third communication device during at least the remaining portion of the scheduling interval if
i) a release indication is received or
ii) no data exchange between the first communication device and the third communication device is observed for at least an inactivity interval.

19. Third communication method of a third communication device configured to communicate with a first and/or second communication device, the third communication method comprising
performing data exchange with the first communication device during a first portion of a scheduling interval, wherein data exchange between the third communication device and the first communication device is planned during the scheduling interval, the first communication device being a primary user of the scheduling interval; and
i) receiving a first release indication from the first communication device indicating that the first communication device has finished data exchange with the third communication device during the scheduling interval and transmitting a second release indication indicating that the remaining portion of the scheduling interval is released for use by a second communication device, the second communication device being a secondary user of the scheduling interval, or
ii) transmitting a first release indication indicating that the third communication device has finished data exchange with the first communication device during the scheduling interval, receiving a second release indication from the first communication device indicating that the remaining portion of the scheduling interval is released for use by a second communication device, and repeating the transmission of the second release indication, or
iii) transmitting a second release indication or other information indicating or allowing a second communication device to determine that the remaining portion of the scheduling interval is released for use by a second communication device.

20. A non-transitory computer-readable recording medium that stores therein a computer program product, which, when executed by a processor, causes the method according to claim 17, 18 or 19 to be performed.
